(19) United States
(12) Patent Application Publication
(10) Pub. No.: US 2003/0089033 A1
(43) Pub. Date: May 15, 2003

(54) Flower grouping organizer

(76) Inventor: William D. Wimp JR., Owensboro, KY (US)

Correspondence Address: BOWERS HARRISON LLP, GARY K. PRICE, ESP., 25 RIVERSIDE DRIVE, PO BOX 1287, EVANSVILLE, IN, 47706-1287, US

(21) Appl. No.: 10/291,460

(22) Filed: Nov. 8, 2002

Related U.S. Application Data
(60) Provisional application No. 60/335,600, filed on Nov. 15, 2001.

(51) Int. Cl. A01G 5/00; A47G 7/00

(52) U.S. Cl. 47/41.11

(57) ABSTRACT

A flower grouping organizer designed to organize a flower grouping of fresh cut flowers, artificial flowers or other floral materials into a pre-selected pattern for display in a vase. The organizer having a pre-selected shape, such as a heart shape. The flower grouping organizer having an outer edge surface, at least one larger drainage opening disposed in or about the center of the organizer, and a plurality of smaller openings sized to receive the stems of the floral grouping, said smaller openings arranged around the periphery of the organizer, and a plurality of cuts disposed between each of the smaller openings and the outer edge surface of the organizer.

### CROSS REFERENCES TO RELATED APPLICATIONS

U.S. Provisional Application for Patent No. 60/335,600, filed Nov. 15, 2001, with title, “Flower Grouping Organizer” which is hereby incorporated by reference. Applicant claims priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

This invention relates to an apparatus for the floral industry; more particularly, this invention relates to an apparatus for organizing a flower grouping in a vase useable for, but not restricted to, fresh cut flowers, artificial flowers or other floral materials which add to the aesthetics of the overall floral grouping. The apparatus provides a method first of arranging the stems of the flowers in a pre-selected order, and resulting in the blooms or foliage likewise being displayed in said pre-selected design or configuration.

2. Background Information

Floral groupings, including fresh cut flowers, artificial flowers or other floral materials can be difficult, especially for a novice, to arrange in a vase or container so as to offer asymmetrical and pleasing arrangement. In general, the stems of the floral grouping are randomly inserted in the open container without particular attention to the organization or design of the floral arrangement once inserted. While the finished product, i.e., a vase floral grouping, remains aesthetically pleasing, the formal grouping lacks any uniformity or design.

Flowers are further arranged at the florist by inserting cut flowers into floral foam. The floral foam is placed into a vase or similar container, and the flower stems are placed in foam. The problem with the foam is that the foam must be wetted and then placed in a vase or the like before the flowers are placed in the arrangement. Arrangements made with floral foam can be asymmetric because the arranger may not balance the flowers in the arrangement. Moreover, the foam may fail to support some of the flowers in the arrangement, causing it to sag with time.

Many types of devices have been proposed to aid both the novice and the professional in arranging flowers and other items in a pleasing and artistic arrangement. These known devices include non-flexible domes or grids, flower foam, bucket lids with openings to hold the flowers, pliable layers over openings and a cantilever workholder having a support with removable, flexible lines held taut therein. These devices are not flexible, and are often not adapted to be used with containers, other than the container for which it is specifically designed. Examples of prior art devices are as follows:

U.S. Pat. No. 3,447,262 which discloses a non-flexible grid having an out annular rim which is positioned over and affixed to an associated container so as to be secured and placed on the container when a floral arrangement is placed within the grid.

U.S. Pat. No. 3,457,673, discloses a floral piece foundation of the type in which stuffing material wrapped in a perforable wrapper is maintained on a base plate by a mesh work or cordage or the like. The cordage is wrapped in a regular pattern over the wrapper to facilitate the making of patterned floral arrangements, and the edges of the base plate are provided with continuous serrations along their full length in which the cordage is received.

U.S. Pat. No. 4,958,461, discloses a floral holder and display which is designed for holding and displaying floral bouquets. The display includes a bucket which is deep enough to contain flower stems. A lid is provided which is shaped and dimensioned to removably fit on the bucket. The lid is formed with a plurality of spaced apart openings thereon. A plurality of sleeves extend downward from the lid and are contained within the bucket when the lid is mounted on the bucket. Each sleeve has an upper open end in communication with a separate lid opening.

U.S. Pat. No. 4,964,237, discloses a device for assembling bouquets including a workholder and support means for supporting the workholder in a cantilever fashion. The workholder includes a platform having an aperture therein and a plurality of flexible lines held taut across the aperture in a grid pattern by retention means. The bouquet is assembled by inserting the stems of flowers in the grid openings in the aperture with the stems extending either toward a base or to a vase portion above the base.

U.S. Pat. No. 5,127,184, discloses a guide for the placement of flora into a flora receiving means such as a flower pot, the guide comprising a base having a central opening for positioning around the flora receiving means and includes a plurality of resilient, elongated wires extending therefrom to form an asymmetrical area such as a dome defined by the wires and base. In the preferred embodiment, a square frame supported by adjustable legs may be positioned to surround the flora receiving means and includes a linear extensions having notches cut or otherwise formed therein for releasable attachment of the base thereto such that the symmetrical area of the base is coaxial with the flora receiving means. The wires of the base define a plurality of spaced openings through which cut flora is passed and inserted stem first into the florist foam such that the free ends of the flora do not extend substantially beyond the area defined by the wires.

While the prior art devices disclosed in the above-mentioned patents provide improvements in the art, there still exists a need in the art for a simple, less costly and easy-to-use, flexibly device which can be used by an expert and/or a novice to easily arrange fresh cut flowers, artificial flowers or other floral materials in a vase so that the blooms or foliage are displayed in a pre-selected design or configuration.

As will be seen from the subsequent description, the preferred embodiment of the present invention overcomes these and other shortcomings of prior art. The apparatus of the present invention includes a method of first arranging the stems of a floral grouping in a pre-selected order, and resulting in the blooms or foliage of the vase floral arrangement likewise being displayed in said pre-selected design or configuration.

### SUMMARY OF THE INVENTION

The present invention is designed to organize a flower grouping of fresh cut flowers, artificial flowers or other floral materials into a pre-selected pattern for display in a vase. The preferred embodiment includes an organizer having a selected-shaped configuration, such as a heart shape, said organizer having a top surface, and including at least one drainage opening disposed in or about the center of the organizer, and a plurality of smaller openings sized to receive and retain the stems of the flowers of the flower grouping. Said smaller openings arranged around the periphery of the top surface of the organizer so that when the stems are received within the small openings and inserted in the vase, the bloom or foliage portion of the floral grouping will display in said pre-selected design or configuration, such as a heart configuration.

### BRIEF DESCRIPTION OF THE DRAWINGS

FIG. 1 is a plan view of the present invention, a flower grouping organizer.

FIG. 2 illustrates a perspective view of the organizer of FIG. 1 with flowers therein.

FIG. 3 illustrates an enlarged perspective view of one of the small holes in the organizer of FIG. 1 having a stem therein.

### DESCRIPTION OF THE PREFERRED EMBODIMENT

The following description is provided to enable any persons skilled in the art to make and use the invention, and sets forth the best modes contemplated by the inventor of carrying out his invention. Various modifications, however, will remain readily apparent to those skilled in the art, since the generic principles of the present invention have been defined herein specifically to provide for a novel and improved and simplified flower grouping organizer 10 shown as having a heart shape configuration, but which could take any desired shape or configuration. The organizer 10 is for use in holding floral groupings, including fresh cut flowers, artificial flowers, and other floral materials in a pre-selected design or configuration, and for placement within a conventional vase or other container.

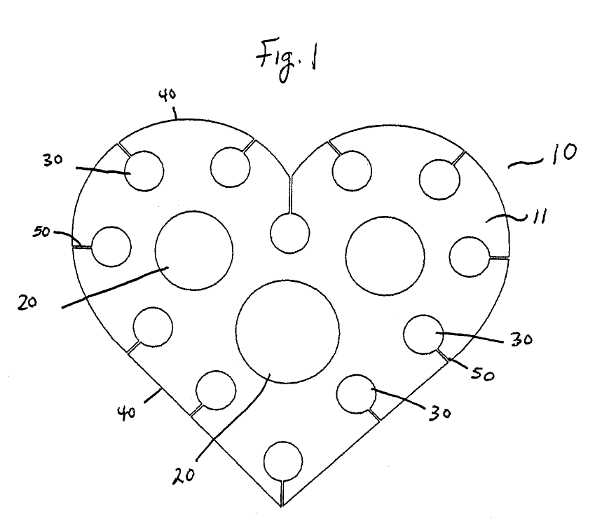

FIGS. 1-3 illustrate a preferred embodiment of the floral grouping organizer 10 made in accordance with the present invention. The flower grouping organizer 10 provides a method first of arranging the stems of the fresh cut flowers, artificial flowers or other floral materials in a pre-selected order, and resulting in the blooms or foliage likewise being displayed in said pre-selected design or configuration.

Specifically, it will be noted in the drawings that the device of the present invention relates to an apparatus and method for organizing a flower grouping in a vase. In the broadest context, the device consists of components configured and correlated with respect to each other so as to attain the desired objective.

As shown in FIG. 1, the organizer 10 having a top surface 11, and includes at least one larger drainage opening 20 therethrough, and a plurality of smaller openings 30 therethrough. Said larger drainage opening disposed in or about the center of the organizer 10. Said smaller openings 30 disposed around the outer periphery of the top surface 11 of the organizer 10. Said smaller openings 30 each sized and configured to receive and retain a stem 110 of a flower 100. Said smaller openings 30 are of equal size.

The organizer 10 further includes an outer edge surface 40 and a plurality of cut portions 50, the number of cut portions 50 being equal to the number of smaller openings 30 in the organizer 10.

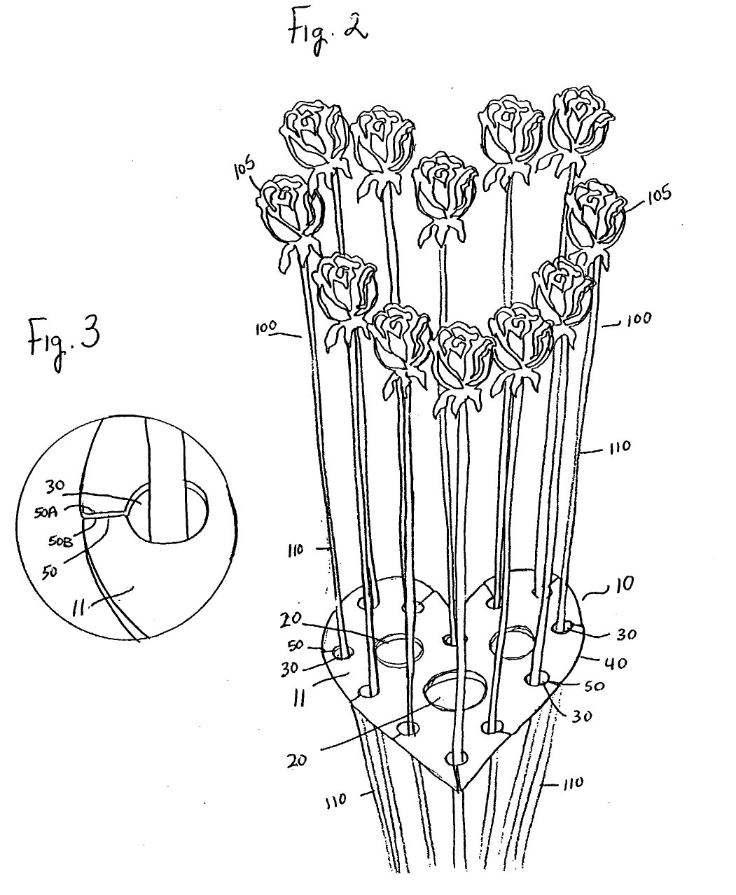

As best shown in FIG. 2, the cut portions 50 are disposed between each of the smaller openings 30 and the outer edge surface 40, said cut portions 50 perpendicular with the outer edge surface 40. As shown in FIG. 3, the cut portion 50 are formed from a first lip 50A, and a second lip 50B adjacent to the first lip 50A. When said lips 50A, 50B are separated, the cut portion 50 allows access to the smaller openings 30 from the outer edge surface 40 of the organizer 10. As such, by separating the lips 50A, 50B, access to the smaller openings 30 is extended to the outer edge surface 40 through the cut portion 50. The stem 110 is slidably inserted through the separated lips 50A and 50B and directly into the smaller openings 30.

The organizer 10 may have, by way of example but not by way of limitation, a heart-shaped configuration as shown in FIGS. 1 and 2, or any other shape as long as the organizer 10 functions as described herein. Further, the organizer 10 may comprise any shape, whether geometric, non-geometric, asymmetrical or fanciful as long as it functions in accordance with the present invention. Preferably, the organizer 10 is constructed from a material that is durable plastic, such as acrylic plastic, which is flexible, semi-rigid, rigid or any combination thereof. The organizer 10 may be constructed of a single layer of material or a plurality of layers of the same or different types of material. While the thickness of the material may vary, preferably the material is relatively thin.

The material comprising the organizer 10 may vary in color and may consist of designs or decorative pattens which are printed or embossed thereon.

The term “floral grouping” as used herein means cut fresh flowers, artificial flowers or other floral materials which add to the aesthetics of the overall flower grouping. The floral grouping comprises said plurality of said flowers 100, each flower 100 including said stem 110 and a bloom or foliage 105. The term floral grouping may be used interchangeably herein with the term floral arrangement.

In use, as best shown in FIGS. 2 and 3, each stem portion 110 of the floral arrangement is inserted in one of the smaller openings 30 by separating the lips 50A and 50B of the cut portion 50 as described above, thereby creating an access path to the smaller opening 30 from the outer edge surface 40. The stem portions 110 are inserted into each of the smaller openings 30 so that a portion of the stems 110 downwardly extend from the lower surface 12 of the organizer 10. Once the stem portions 110 are inserted into each of the smaller openings 30, the stem portions 110 downwardly extending from the organizer 10 are inserted into a vase or container (not shown), while the stem portions 110 above the organizer extend to the bloom or foliage 105. Once the stems 110 are inserted in the vase, the stems 110 above the organizer 10 and the blooms or foliage 105 will be situated like the pre-selected positions of the smaller openings 30 on the organizer 10. Once the stems 110 are inserted in the vase as described above, the organizer 10 may rest on or within the top surface of the vase.

For purposes of example, the organizer 10 was selectively configured in a heart shape and as such, the smaller openings 30 as shown in FIG. 2, were cut at pre-selected locations around the periphery of the organizer 10, to likewise form a heart-shaped configuration. As a result, once the stems 110 are inserted in the smaller openings 30 as discussed above, the bloom or foliage 105 of the flowers 100 likewise form and display a heart-shaped configuration as shown in FIG. 2. Once the stems 110 are in the vase, additional water or fertilizer may be inserted in the vase through the larger drainage openings 20 disposed in or around the center of the organizer 10.

Although the description above contains many specificities, these should not be construed as limiting the scope of the invention, but as merely providing illustrations of a presently preferred embodiment of this invention.

The organizer 10 may be, by way of example, heart-shaped as shown in FIGS. 1 and 2, however it is understood that any other shape may be used as long as the organizer 10 functions as described herein. Likewise, the smaller openings 30 of the organizer 10 may be configured on the organizer 10 in any shape as long as the organizer 10 functions as described herein. Further, the organizer 10 may be of a variety of sizes as long as the organizer 10 functions as described herein.

Thus the scope of the invention should be determined by the appended claims in the formal application and their legal equivalents, rather than by the examples given.

I claim:

1. A flower grouping organizer for facilitating an arrangement of cut flowers, artificial flowers or other floral materials in a pre-selected pattern for display in a vase, said cut flowers having a stem portion and a bloom portion, said flower grouping organizer comprising:
an organizing member having a top surface and a lower surface, at least one larger drainage opening, a plurality of smaller openings selectively disposed around the outer periphery of the top surface of the organizer member, an outer edge surface, and a plurality of cut portions, the number of cut portions equal to the number of smaller openings,
wherein said cut portions formed by a first lip and a second lip adjacent the first lip, said cut portions disposed between the smaller openings and the outer edge surface, and said cut portions being perpendicular with the outer edge surface,
wherein said larger drainage openings disposed in or about the center of the organizer,
wherein the organizer member having a pre-selected shape,
wherein the stem of the flower is slidably inserted through the separated first and second lips and nested in the smaller opening,
wherein the stems of the flowers extend downwardly from the smaller openings of the lower surface of the organizing member into the vase.

2. The flower grouping organizer as recited in claim 1, wherein separating the first and second lips allow access to the smaller opening from the outer edge surface.

3. The flower grouping organizer as recited in claim 1, wherein the organizing member is constructed from a material that is durable plastic.

4. The flower grouping organizer as recited in claim 1, wherein the organizing member having a heart shaped configuration.

5. The flower grouping organizer as recited in claim 1, wherein the smaller openings are of equal size.

6. A flower grouping organizer for facilitating an arrangement of cut flowers, artificial flowers or other floral materials in a pre-selected pattern for display in a vase, said cut flowers having a stem portion and a bloom portion, said flower grouping organizer comprising:
an organizing member having a top surface and a lower surface, at least one larger drainage opening, a plurality of smaller openings selectively disposed around the outer periphery of the top surface of the organizer member, an outer edge surface, and a plurality of cut portions, the number of cut portions equal to the number of smaller openings,
wherein said cut portions are disposed between the smaller openings and the outer edge surface, said cut portions being perpendicular with the outer edge surface,
wherein the organizer member having a pre-selected shape,
wherein the stem of the flower is slidably inserted in the smaller opening,
wherein the stems of the flowers extend downwardly from the smaller openings of the lower surface of the organizing member into the vase.

7. The flower grouping organizer as recited in claim 6, wherein the organizing member is constructed from a material that is durable plastic.

8. The flower grouping organizer as recited in claim 6, wherein the organizing member having a heart shaped configuration.

9. The flower grouping organizer as recited in claim 6, wherein the smaller openings are of equal size.

10. A method of organizing an arrangement of cut flowers, artificial flowers or other floral materials in a pre-selected pattern for display in a vase comprising:
positioning an organizer member having a plurality of smaller openings, said organizer member further including a top surface and a lower surface, at least one larger drainage opening, an outer edge surface, and a plurality of cut portions disposed between the smaller openings and the outer edge surface,
slidably inserting a stem of the flowers through each of the cut portions,
nesting the stem of the flowers in each of the smaller openings,
placing the stems of the flowers in the display vase.

11. The method of arranging the cut flowers, artificial flowers or other floral materials of claim 10 further including the step of positioning the smaller openings around the outer periphery of the top surface of the organizer member.

12. The method of arranging the cut flowers, artificial flowers or other floral materials of claim 10 further including the step of shaping the organizer member in a selected configuration.

13. The method of arranging the cut flowers, artificial flowers or other floral materials of claim 12, wherein the organizing member having a heart shaped configuration.
